(19) United States
(12) Patent Application Publication
(10) Pub. No.: US 2010/0038227 A1
(43) Pub. Date: Feb. 18, 2010

(54) Touch detected voice-prompted 2-stage keypad

(75) Inventor: Whei-Li Lu, Taipei City (TW)

Correspondence Address: BACON & THOMAS, PLLC, 625 SLATERS LANE, FOURTH FLOOR, ALEXANDRIA, VA, 22314-1176, US

(73) Assignee: Wintone Technology, Inc., Taipei (TW)

(21) Appl. No.: 12/222,625

(22) Filed: Aug. 13, 2008

(51) Int. Cl. H01H 13/76

(52) U.S. Cl. 200/5 A

(57) ABSTRACT

The present invention discloses a touch detected voice-prompted 2-stage keypad. The keypad has a touching detector switch (first stage) and a contact switch (second stage). The touching signal of a finger is identified by the detector and then input to the microprocessor, a number or a function (voice) represent this keypad is output to a speaker, the user confirms that this keypad is the required one, thus press the contact switch to output a signal to the microprocessor to execute the function of this key. The touch detected voice-prompted 2-stage key may form an array of numbers and/or functions, and control by touching instead of viewing. It is convenient in the night, for a blind or weak sighted people.

### BACKGROUND OF THE INVENTION

1. Field of the Invention

The present invention relates to a 2-stage keypad. In particular, the present invention relates to a touch detected voice-prompted 2-stage keypad, the touching of a finger is detected by the touching switch, then the numbers and/or functions of this switch is prompted and confirmed by the user, then the user presses the contact switch to execute the function of this key. It is convenient in the night, for a blind or weak sighted people

2. Description of the Related Art

Generally, a keypad operating with fingers is contact keypad, those operating with a single finger such as telephones, cellular phones, calculators and keypad of a personal computer has used for a long times. FIG. 1 is a schematic diagram of a contact keypad of the prior art. FIG. 1(A) is a schematic basic circuit diagram of the contact key 100. Contact circuit membrane 104 has a contact terminal 105 and a contact terminal 107 which form the basic circuit. FIG. 1(B) is the viewing diagram of a contact keypad 100 which shows the number “0” and the function “#”. FIG. 1(C) is a cross-sectional diagram through the line A₁-A₁ of FIG. 1(B). On the supporting plate 102, there is the contact circuit membrane 104, every key has a sheet spring 108 and a keycap 106 on the top, under the keycap 106, there is a key support 110. As a user presses the keycap 106, the key support 110 will press the sheet spring 108 such that contact terminal 105 and contact terminal 107 will conduct, this conducting signal is transferred to a microprocessor to execute the function or output a signal of this key. For using in the night, for a blind or weak sighted people, some technologies use a dimple or a bar on the center of the key array in remote controllers, cellular phones or calculators, this technology is used in U.S. Pat. No. 5,183,078. For much more keys, such as the keypad of a personal computer, more than 2 dimples or bars may be used. By touching the dimple or the bar, one will recognize the present key and the corresponding keys around it and need not view by sight.

FIG. 2 is a schematic diagram of a touching switch keypad of the prior art. FIG. 2(A) s a schematic basic circuit diagram of the touching key 200. FIG. 2(B) is the viewing diagram of a touching key 200 which shows the number “0” and the function “#”. FIG. 2(C) is a cross-sectional diagram through the line B₁-B₁ of FIG. 1(B). On the supporting plate 102, there is the sensing plate membrane 204. As the finger of a user touching the keycap 106, the capacitance of the sensing plate membrane 204 will change and the oscillation frequency of the touching detector to detect the touching of a finger on the keycap 106, then the microprocessor will execute the function or output a signal of this key. The technology is used in R.O.C. Taiwan PAT. NO. 09411758 to Lin, Shyuh Der, U.S. Ser. No. 11/125,598 and Japan PAT. NO. 2005358354 to Lin, Shyuh Der. Also used in U.S. Pat. No. 6,583,676 B2 to Christoph H. Krah et al. Another method is by connecting the sensing plate membrane 204 to the input of an oscillator. The change of the input capacitance of the oscillator will change the output voltage. Around these is by feeding a alternating signal by the sensing plate membrane 204 to the amplifier, the change of the sensing plate membrane capacitance will change the output voltage, the output voltage will be detected at the output of the amplifier. This technology is used in U.S. Pat. No. 5,374,787; U.S. Pat. No. 6,610,936 B2 to Robert J. Miller et al. the system using this technology including a lot of analog circuits such as amplifiers, filters, minimum selector, substractors, sampling/holders and A/D converters. Harald Philip in U.S. Pat. No. 6,452,514 B1 teaches a charge transfer circuit. In this circuit, alternating signal is applied to one sensing plate membrane, and the other sensing plate membrane will feed the signal to a signal processor. The signal processor includes analog circuits such as peak detectors, amplifiers and A/D converters. The other method is by connecting the sensing plate membrane to the input of the oscillator, the change input capacitance of the oscillator will change the frequency of the oscillator. By detecting the change of the frequency, the proximating of the finger to the sensing plate membrane can be detected.

The above prior arts are using the sensing plate membrane to detect the proximating of the finger to the sensing plate membrane only.

What is need is to have a touching switch to detect the touching of a finger and then the numbers and/or functions of this switch is reported, the user confirms this is the correct key, and then presses the contact switch to execute the function of this key.

### OBJECTS OF THE INVENTION

It is therefore an object of the invention to provide a touch detected voice-prompted 2-stage keypad by using a touching switch to detect the touching of a finger and then the numbers and/or functions of this switch is prompted with a voice by a speaker, the user confirms this is the correct key, and then presses the contact switch to execute the function of this key.

It is another object of the invention to provide a touch detected voice-prompted 2-stage keypad by using touching switch and contact switch to form an array so that the cellular phone, remote controller or controller can be used in the night, for a blind or weak sighted people.

### DISCLOSURE OF THE INVENTION

In order to achieve the above and other objects, a first aspect of the present invention teaches a touch detected voice-prompted 2-stage key, two switches are put in a key, a touching switch and a contact switch, by touching the touching switch with a finger, a number or function of this key will prompt with voice by a speaker, then the user will acknowledge whether the number or function is the required one, and then press down the contact switch to execute the function of this key, control by touching instead of viewing, it is convenient in the night, for a blind or weak sighted people, including: A touching switch, having a sensing plate membrane to sense the touching of a finger; A touching detector, the signal of the sensing plate membrane is detected by the sensing plate membrane and then input to a microprocessor; A speaker, use to output the voice; A microprocessor, processing the signal from the touching detector to determine the finger has touching the touching switch, and a number or a function represent this keypad is output by the microprocessor to the speaker, then prompt the number or function in voice; A contact switch, output signal to the microprocessor, if the user determined that the number or function is correct, then press down the contact switch such that the contacts are conducted, the microprocessor will execute the function of this key.

Another preferred embodiment of the present invention teaches a touch detected voice-prompted 2-stage keypad, two switch are put in every key of the keypad, a touching switch and a contact switch, by touching the touching switch with a finger, a number or function of this key will prompt with voice by a speaker, then the user will acknowledge whether the number or function is the required one, and then press down the contact switch to execute the function of this key, control by touching instead of viewing, it is convenient in the night, for a blind or weak sighted people.

### BRIEF DESCRIPTION OF THE DRAWINGS

The foregoing and other advantages of the invention will be more fully understood with reference to the description of the best embodiment and the drawing wherein:

FIG. 1 is a schematic diagram of a contact keypad of the prior art;

FIG. 1(A) is a schematic basic circuit diagram of the contact key 100;

FIG. 1(B) is the viewing diagram of a contact keypad 100 which shows the number “0” and the function “#”;

FIG. 1(C) is a cross-sectional diagram through the line A₁-A₁ of FIG. 1(B).

FIG. 2 is a schematic diagram of a touching switch keypad of the prior art;

FIG. 2(A) is a schematic basic circuit diagram of the touching key 200;

FIG. 2(B) is the viewing diagram of a touching key 200 which shows the number “0” and the function “#”;

FIG. 2(C) is a cross-sectional diagram through the line B₁-B₁ of FIG. 1(B).

FIG. 3 is a schematic diagram of a touch detected voice-prompted 2-stage keypad in according to one embodiment of the present invention.

FIG. 3(A) is the viewing diagram of a voice-prompted 2-stage keys 300 which shows the number “0” and the function “#”.

FIG. 3(B) is a cross-sectional diagram through the line C₁-C₁ of FIG. 3(A).

FIG. 4 is a circuit diagram of a touch detected voice-prompted 2-stage key 500 in according to another embodiment of the present invention.

FIG. 5 is a circuit diagram of a touch detected voice-prompted 2-stage keypad array in according to one embodiment of the present invention.

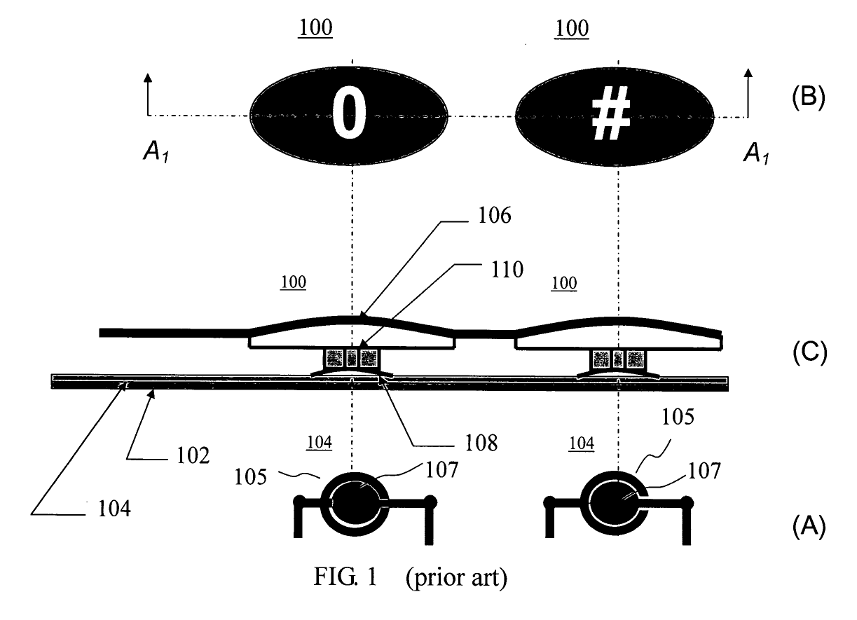

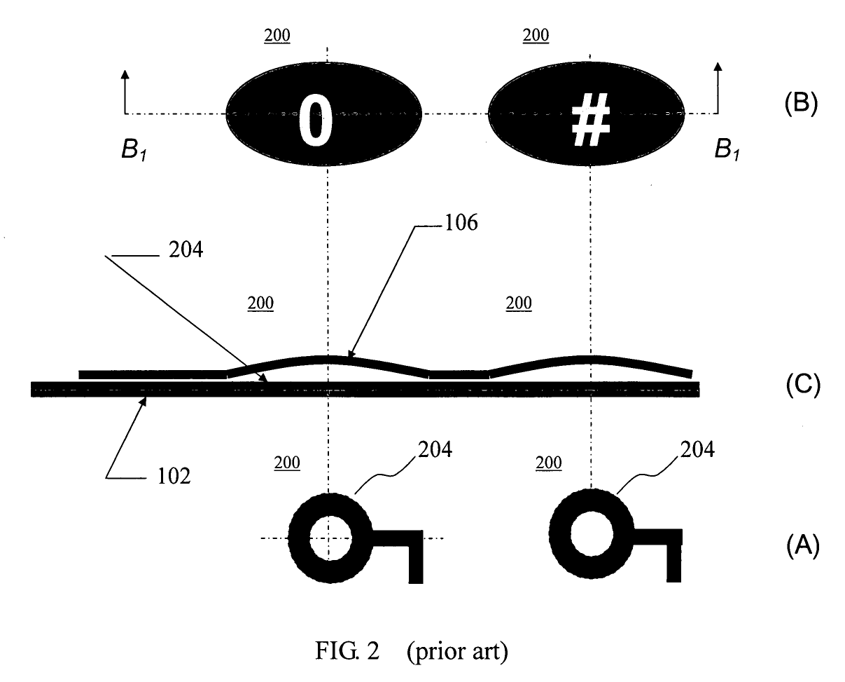

### DESCRIPTION OF THE PREFERRED EMBODIMENTS

The foregoing and other advantages of the invention will be more fully understood with reference to the description of the best embodiment and the drawing as the following description.

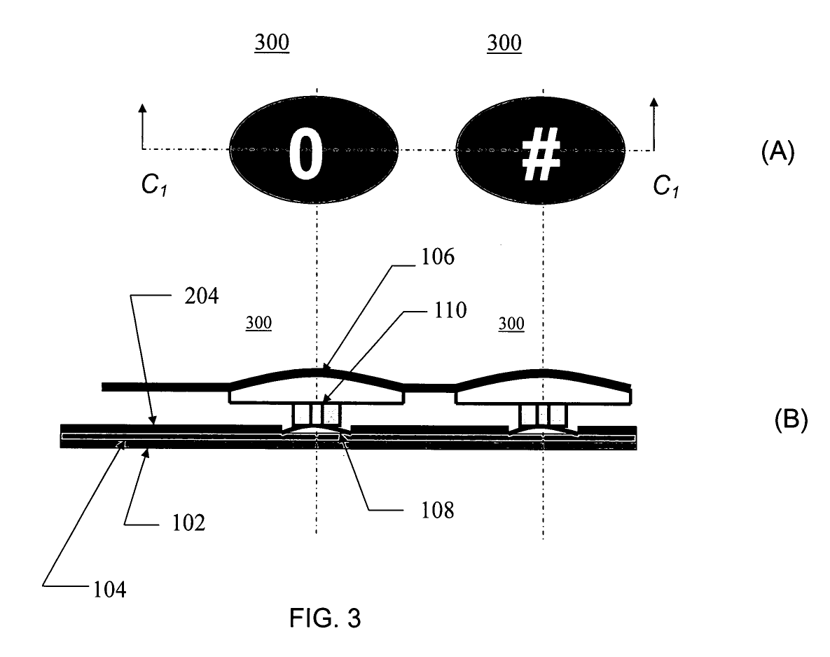

Refer to FIG. 3, FIG. 3 is a schematic diagram of a touch detected voice-prompted 2-stage keypad in according to one embodiment of the present invention. FIG. 3(A) is the viewing diagram of a voice-prompted 2-stage keys 300 which shows the number “0” and the function “#”. FIG. 3(B) is a cross-sectional diagram through the line C₁-C₁ of FIG. 3(A). On the supporting plate 102, there is a sensing plate membrane 204. As the finger of a user touching the keycap 106, the capacitance of the sensing plate membrane 204 will change so that the detector will detect the touching of a finger on the keycap 106, then the microprocessor will execute the function or output a special signal. On the supporting plate 102, there is also a contact circuit membrane 104. Every key has a sheet spring 108 and a keycap 106 on the top, under the keycap 106, there is a key support 110. As a user confirms that this key is the he need, and then presses the keycap 106, the key support 110 will press the sheet spring 108 such that contact terminals will conduct, this conducting signal is transferred to a microprocessor to execute the function or output a special signal of this key.

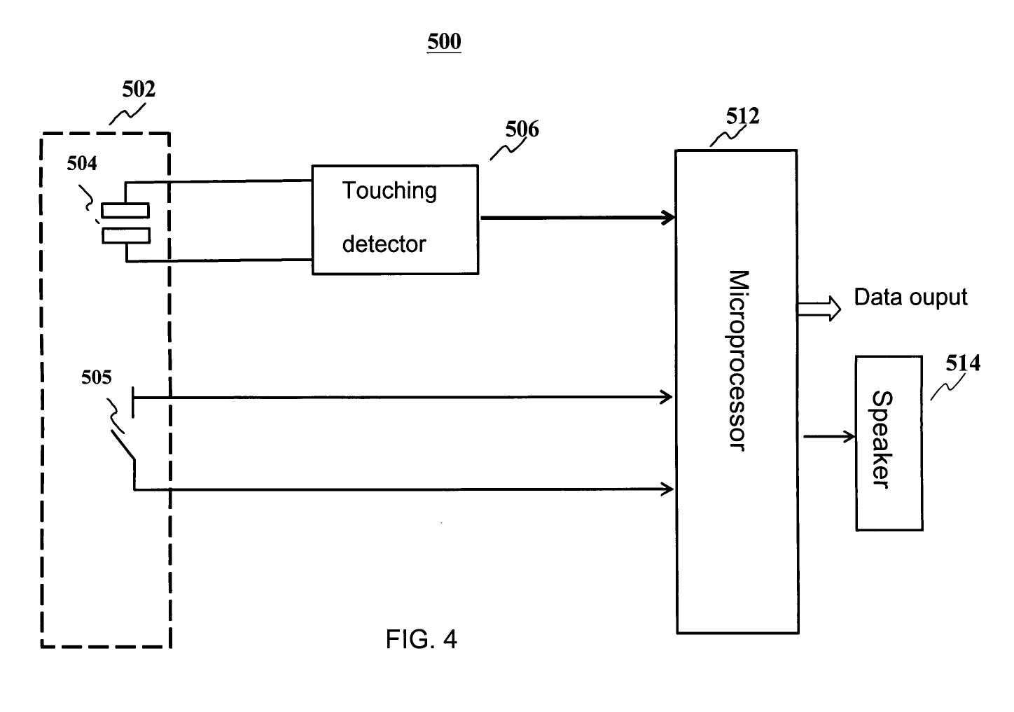

Refer to FIG. 4, FIG. 4 is a circuit diagram of a touch detected voice-prompted 2-stage key 500 in according to another embodiment of the present invention. The voice-prompted 2-stage key 502 includes a touching switch 504 and a contact switch 505. The ON signal of the contact switch 505 is input to the microprocessor 512 directly to execute the function of this key. When a finger touching the touching switch 504, a signal is detect by the touching detector 506 and input to the microprocessor 512, the sensitivity of the touching detector 506 can be programmed. As the microprocessor 512 determines that a finger is touching the touching switch 504, a number or function of this key will output to a speaker 514, then the user will acknowledge whether the number or function is the required one. If yes, the user then press down the contact switch 505, the ON signal of the contact switch 505 is input to the microprocessor 512 directly to execute the function of this key. If no, the user will not press down the contact switch 505 and continue to select the other key.

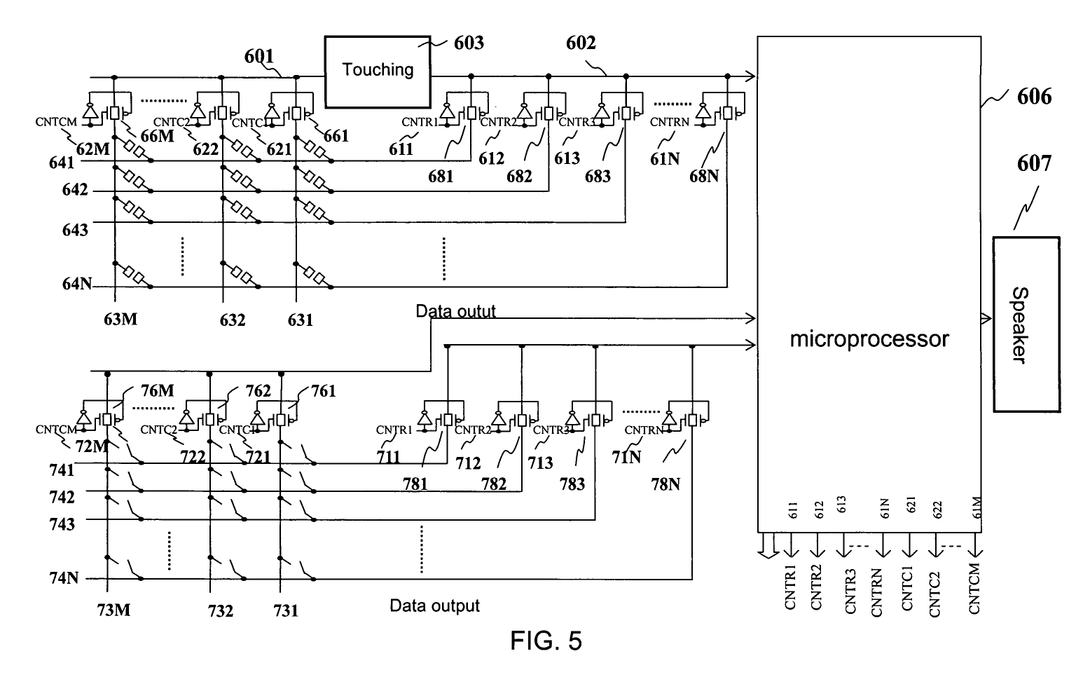

FIG. 5 is a circuit diagram of a touch detected voice-prompted 2-stage keypad array in according to one embodiment of the present invention. Refer to part 1 (upper left) the circuit diagram of the touch detected voice-prompted key array of FIG. 5. M transmission gates (661-66M) are parallelly connected to the input terminal 601 of the touching detector 603. N transmission gates (681-68N) are parallelly connected to the input terminal 602 of the touching detector 603. The output of the transmission gates forms a M×N matrix. A touching switch array is formed by connecting one of the sensing plate to the output of the Mth transmission gate, another sensing plate is connected to the output 64N of the Nth transmission gate. The control gates (611-61N and 621-62M) of transmission gates (681-68N [symbol] 661-66M) are connected to the corresponding output (611-61N and 621-62M) of a microprocessor 606, microprocessor 606 output a series of sweeping signals (CNTR1-CNTRN and CNTR1-CNTRM) to scan every touching switch. Touching one of the touching switch by a finger such that the touching detector detects the touching of the finger, the microprocessor 606 determines that a finger is touching one of the touching switches, a number or function of this key will output to a speaker 607, then the user will acknowledge whether the number or function is the required one.

Refer to part 2 (lower left) the circuit diagram of the contact switch array of FIG. 5. M transmission gates (761-76M) are parallelly connected to the microprocessor 606. N transmission gates (781-78N) are also parallelly connected to microprocessor 606. The output (731-73M) and (741-74N) of these transmission gates forms an M×N matrix. A contact switch array can be form by connecting one of the contact to the output 73M of the Mth transmission gate, and connecting another contact to the output 7M of the Nth transmission gate. The control gates (711-71N and 721-72M) of these transmission gates (781-78N) and (761-76M) are connecting to the corresponding output (611-61N and 621-62M) of microprocessor 606. Microprocessor 606 output a series of sweeping signals (CNTR1-CNTRN and CNTR1-CNTRM) to scan every contact switch. If the two contacts of a contact switch is conduced (pressed) during sweeping, it can be determined that a contact switch is pressed, microprocessor 606 will execute the function of this key. Under very touching switch there is a corresponding contact switch.

Although specific embodiments of the invention have been disclosed, it will be understood by those having skill in the art that minor changes can be made to the form and details of the specific embodiments disclosed herein, without departing from the scope of the invention. The embodiments presented above are for purposes of example only and are not to be taken to limit the scope of the appended claims.

What is claimed is:

1. A touch detected voice-prompted 2-stage key, two switches are put in a key, a touching switch and a contact switch, by touching the touching switch with a finger, a number or function of this key will prompt with voice by a speaker, then the user will acknowledge whether the number or function is the required one, and then press down the contact switch to execute the function of this key, control by touching instead of viewing, it is convenient in the night, for a blind or weak sighted people, comprising:
a touching switch, having a sensing plate membrane to sense the touching of a finger;
a touching detector, the signal of said sensing plate membrane is detected by said sensing plate membrane and then input to a microprocessor;
a speaker;
a microprocessor, processing the signal from said touching detector to determine the finger has touching said touching switch, and a number or a function represent this keypad is output by the microprocessor to said speaker, then prompt the number or function in voice;
a contact switch, output signal to said microprocessor, if the user determined that the number or function is correct, then press down said contact switch such that the contacts are conducted, said microprocessor will execute the function of this key.

2. A touch detected voice-prompted 2-stage keypad, two switch are put in every key of the keypad, a touching switch and a contact switch, by touching the touching switch with a finger, a number or function of this key will prompt with voice by a speaker, then the user will acknowledge whether the number or function is the required one, and then press down the contact switch to execute the function of this key, control by touching instead of viewing, it is convenient in the night, for a blind or weak sighted people, comprising:
a touching detector, the signal of said sensing plate membrane is detected by said sensing plate membrane and then input to a microprocessor;
a speaker;
a microprocessor, processing the signal from said touching detector to determine the finger has touching said touching switch;
M transmission gates are parallelly connected to the input of said touching detector, N transmission gates are parallelly connected to the output of said touching detector, the outputs of these transmission gates form an M×N matrix, the control gates of these transmission gates are connected to the corresponding sweep outputs of said microprocessor;
an M×N matrix of touching switch, every touching switch has its sensing plate membrane, one of the sensing plate is connected to the output of the Mth transmission gate, another sensing plate is connected to the output of the Nth transmission gate to form a touching switch matrix, touching one of the touching switch by a finger such that said touching detector detects the touching of the finger, a number or function of this key will output to a speaker from the microprocessor, and prompt the number or function of this key in voice;
M transmission gates are parallelly connected to the input of said microprocessor, N transmission gates are parallelly connected to another input of said microprocessor, the outputs of these transmission gates form an M×N matrix, the control gates of these transmission gates are connected to the corresponding sweep outputs of sad microprocessor;
an M×N matrix of contact switches, every contact switch has a pair of contact terminals, one of the contact terminals is connected to the output of the Mth transmission gate, another contact terminals is connected to the output of the Nth transmission gate to form a contact switch matrix, a user determined that the number or function is correct, then press down said contact switch such that the contacts are conducted, said microprocessor will execute the function of this key.
